(19) United States
(12) Patent Application Publication
(10) Pub. No.: US 2024/0200279 A1
(43) Pub. Date: Jun. 20, 2024

(54) DECREASING FIBER DENSITY IN WET PARTS FORMED FROM SLURRIES

(71) Applicant: Hewlett-Packard Development Company, L.P., Spring, TX (US)

(72) Inventor: John Joseph BRIDEN, Palo Alto, CA (US)

(21) Appl. No.: 18/286,130

(22) PCT Filed: Apr. 13, 2021
(86) PCT No.: PCT/US2021/027115

§ 371 Date: Oct. 8, 2023

(51) Int. Cl. D21J 5/00; A62B 23/02; B01D 39/16; D21H 27/08

(52) U.S. Cl. CPC D21J 5/00; A62B 23/025; B01D 39/1615; D21H 27/08; B01D 2239/10

(57) ABSTRACT

According to examples, a wet part composed of fibers may be removed from a slurry of the fibers on a forming screen having pores, the wet part having a first surface in contact with the forming screen. A second surface of the wet part may be pulled away from the first surface of the wet part while a suction force is applied onto the first surface through the pores in the forming screen to cause a density at which the fibers are arranged in the wet part to be decreased. In addition, following a predefined length of time after initiation of the pulling of the second surface away from the first surface, the wet part may be removed from the forming screen, in which an article formed from the wet part is to function as a filter following the wet part being dried.

### BACKGROUND

Various types of products may be fabricated from a pulp of material. Particularly, a pulp molding die that includes a forming mold and a wire mesh may be immersed in the pulp of material and the material in the pulp may form into the shape of the forming mold and the wire mesh. The main body and the wire mesh may have a desired shape of the product to be formed and may thus have a complex shape in some instances. The main body and the wire mesh may include numerous pores for liquid passage, in which the pores in the wire mesh may be significantly smaller than the pores in the main body. During formation of the product, a vacuum force may be applied through the pulp molding die, which may cause the material in the pulp to be sucked onto the wire mesh and form into a shape that matches the shape of the pulp molding die. The material may be removed from the wire mesh and may be solidified to have the desired shape.

### BRIEF DESCRIPTION OF THE DRAWINGS

Features of the present disclosure are illustrated by way of example and not limited in the following figure(s), in which like numerals indicate like elements, in which:

FIG. 1 shows a flow diagram of a method for forming an article from a wet part composed of fibers, in which the article is to function as a filter following the wet part being dried;

FIGS. 2A and 2B, respectively, depict, cross-sectional side views of an example forming tool and an example transfer tool that may implement some of the operations listed in the method depicted in FIG. 1;

FIG. 2C depicts a cross-sectional side view of an example implementation of the example forming tool and the example transfer tool depicted in FIGS. 2A and 2B during an expansion operation of a wet part;

FIG. 2D depicts a cross-sectional side view of the example forming tool 200 and the example transfer tool depicted in FIGS. 2A and 2B during a transfer operation of a wet part from the example forming tool to the example transfer tool;

FIG. 3A depicts an isometric diagram of an example article formed of molded fibers, in which the article may be porous and may allow a predefined level of fluid to flow through the article:

FIGS. 3B and 3C, respectively, depict a perspective top view and a perspective bottom view of an example article that may be fabricated through implementation of the method depicted in FIG. 1;

FIG. 4 shows a block diagram of an example computer-readable medium that may have stored thereon computer-readable instructions for causing a second surface of a wet part formed on a forming screen to be pulled away from a first surface of the wet part to decrease a density at which fibers in the wet part are arranged; and

FIG. 5 shows a flow diagram of an example method for de-densifying a wet part formed of fibers.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are methods and computer-readable on which are stored instructions for decreasing a density at which fibers in a wet part are arranged. As discussed herein, the wet part may be formed on a forming screen of a forming tool while the forming screen is immersed in a volume of a slurry of fibers. For instance, the wet part may be formed on the forming screen through a molded fiber part fabrication process in which a vacuum force is applied through the forming screen to cause some of the fibers in the slurry to aggregate on the forming screen and form into the wet part. Following formation of the wet part on the forming screen, the forming screen and the wet part may be removed from the slurry.

According to examples of the present disclosure, while a first surface of the wet part is in contact with the forming screen, a second surface of the wet part may be pulled away from the first surface to cause a density at which the fibers are arranged in the wet part to be decreased. As discussed herein, a transfer tool having a transfer mold and a transfer screen may be implemented to pull the second surface of the wet part away from the first surface of the wet part. For instance, the transfer mold may be moved toward the forming screen such that the transfer screen may be positioned on or near the second surface of the wet part while the first surface of the wet part is in contact with the forming screen. In addition, a vacuum pressure, or equivalently, a suction force, may be applied onto both the first surface and the second surface of the wet part such that the first surface may remain in contact with the forming screen and the second surface may be pulled toward the transfer screen.

During the pulling of the second surface, the second surface may be in contact with the transfer screen, which may include pores that may be relatively smaller in size than the fibers in the wet part. The pores may be provided over a relatively large area of the transfer screen and the vacuum pressure may be applied through some or all of the pores. As a result, a vacuum pressure may be applied across a relatively large portion of the second surface of the wet part in a substantially even manner. The pulling of the second surface through use of the transfer screen disclosed herein may enable the fibers in the wet part to be expanded to an intended thickness while reducing or minimizing a risk of damage to the second surface. Additionally, the use of the transfer screen may enable some of the liquid in the wet part to be removed from the wet part through the transfer tool and for the second surface of the wet part to have a smoothness that is equivalent to the smoothness of the first surface of the wet part.

In some examples, the transfer screen may be positioned at a predefined distance from the second surface such that a gap may be created between the transfer screen and the second surface. In these examples, as the vacuum force is applied, the second surface of the wet part may be pulled across the gap such that the spaces between some of the fibers in the wet part may expand. In other examples, the transfer screen may be positioned on the wet part and may be pulled away from the forming screen while the vacuum force is applied to cause the second surface to be pulled away from the first surface and the spaces between some of the fibers in the wet part to expand. In any of these examples, the expansion of the spaces between the fibers in the wet part may decrease the density at which the fibers are arranged in the wet part, e.g., the wet part may be de-densified.

The vacuum force may be applied through the transfer screen and the forming screen for a predefined length of time. The predefined length of time may be selected to enable the fibers in the wet part to at least partially be set in place with respect to each other at the decreased density. The fibers may partially be set in place through removal of some of the liquid in the wet part and partial drying of the fibers. The fibers may more permanently be set in place following a more complete drying of the wet part, for instance, in an oven.

According to examples, the wet part may be formed with various properties, e.g., thickness, fiber concentration level, and/or the like, and the wet part may be pulled a certain distance to cause an article formed from the wet part after the wet part is dried to have a certain fluid flow characteristic. For instance, the article may be formed to have a certain porosity that enables fluid, e.g., a liquid, such as water, and/or a gas, such as air or other type of gas, to flow through the article at an intended flow rate, that enables fluid to flow through the article while blocking a certain minimum percentage of particulates from flowing through the article, and/or the like. By way of particular example, the article may be a filtering face mask and may filter out 95 percent or more of airborne particulates. In other examples, the article may be another type of filter, such as a filter for a pipe, a filter for a vent, and/or the like.

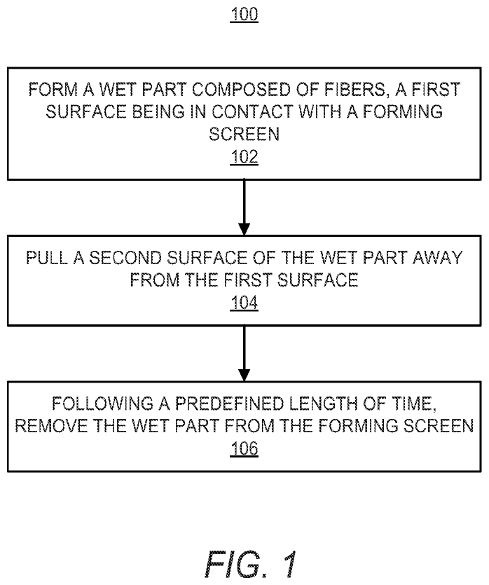

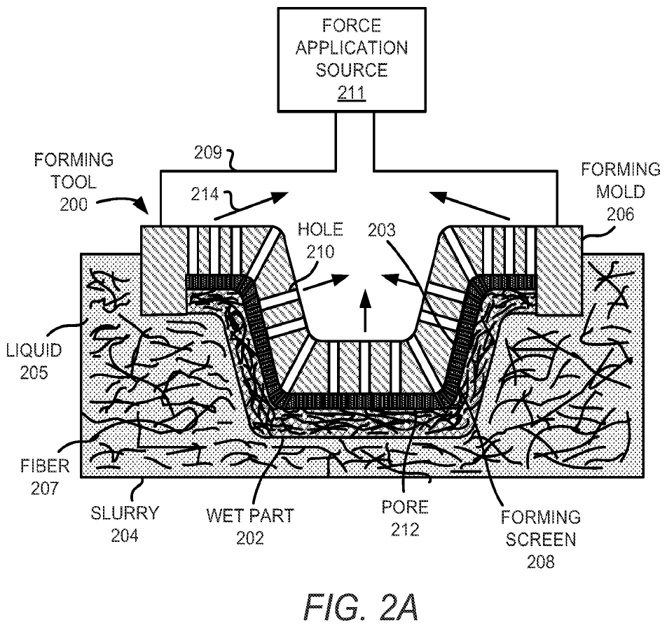

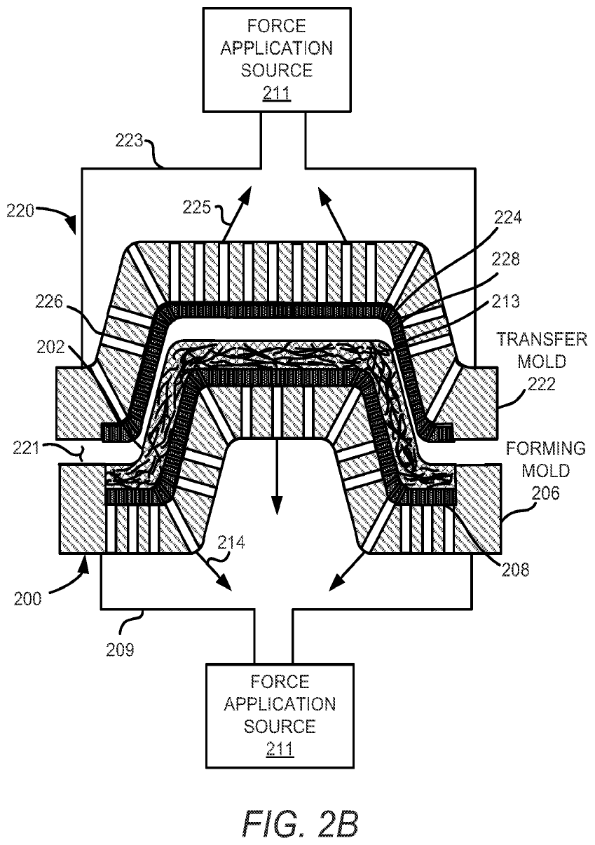

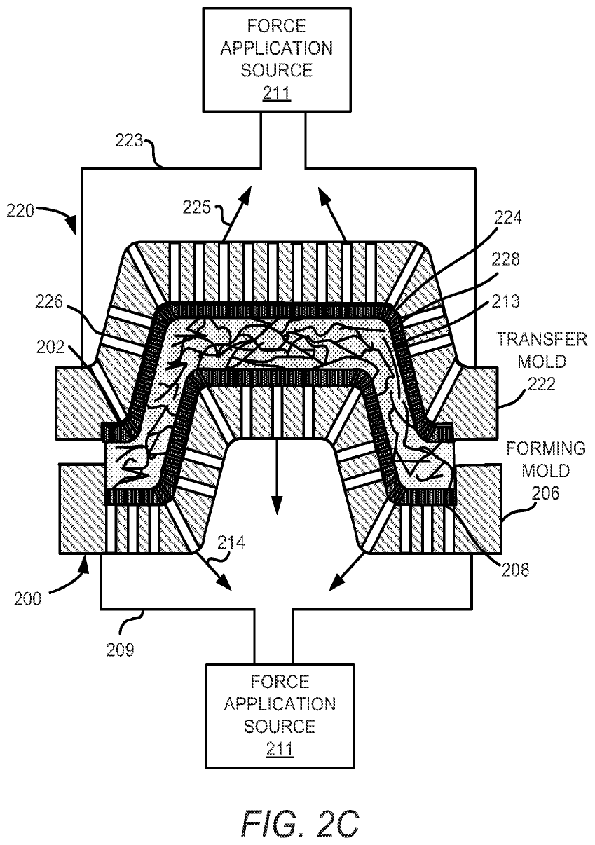

Reference is first made to FIGS. 1 and 2A-2D. FIG. 1 shows a flow diagram of a method 100 for forming an article from a wet part composed of fibers, in which the article is to function as a filter following the wet part being dried. FIGS. 2A and 2B, respectively, depict, cross-sectional side views of an example forming tool 200 and an example transfer tool 220 that may implement the method 100. FIG. 2C depicts a cross-sectional side view of an example implementation of the example forming tool 200 and the example transfer tool 220 depicted in FIGS. 2A and 2B during an expansion operation of a wet part. FIG. 2D depicts a cross-sectional side view of the example forming tool 200 and the example transfer tool 220 depicted in FIGS. 2A and 2B during a transfer operation of a wet part from the example forming tool 200 to the example transfer tool 220. It should be understood that the example method 100 depicted in FIG. 1 and the example forming tool 200 and the example transfer tool 220 depicted in FIGS. 2A-2D may include additional attributes and that some of the attributes described herein may be removed and/or modified without departing from the scopes of FIGS. 1-2D.

With particular reference to FIGS. 1 and 2A, at block 102, a wet part 202 composed of fibers 207 may be formed from a slurry 204 of the fibers 207 on a forming screen 208. The wet part 202 may include a first surface 203 that is in contact with the forming screen 208. As shown in FIG. 2A, the forming screen 208 may be part of a forming tool 200, which may also include a forming mold 206. The forming screen 208 may be mounted onto the forming mold 206 and the forming mold 206 and the forming screen 208 may have shapes to which the wet part 202 may be molded when formed on the forming screen 208.

As shown, the forming mold 206 may have a relatively larger thickness than the forming screen 208. The larger thickness of the forming mold 206 may cause the forming mold 206 to be substantially more rigid than the forming screen 208. The forming mold 206 may provide structural support for the forming screen 208. By way of particular non-limiting example, the forming screen 208 may have a thickness in the range of about 1 mm and 2 mm and the forming mold 206 may have a thickness in the range of about 5-8 mm. The thicknesses of the forming screen 208 and/or the forming mold 206 may be based on, for instance, characteristics of the molded fiber part, characteristics of the fiber 207, processes that the forming tool 200 is to undergo, and/or the like. The characteristics may include the type of the fiber 207 in the slurry 204, the concentration of the fiber 207 in the slurry 204, the sizes of the fiber 207 in the slurry 204, the pressures applied through the forming tool 200 during formation of the wet part 202, the lengths and widths of the forming tool 200, and/or the like. The thicknesses of the forming mold 206 and/or the forming screen 208 may thus vary for different types of forming machines and applications.

As also shown, the forming mold 206 may include holes 210 and the forming screen 208 may include pores 212, in which the holes 210 may have diameters that are larger than the diameters of the pores 212. For instance, the diameters of the holes 210 may be larger than the sizes of the fibers 207 whereas the diameters of the pores 212 may be smaller than the sizes of the fibers 207. That is, the pores 212 may have sufficiently small dimensions, e.g., diameters or widths, that may enable the liquid 205 to flow through the pores 212 while blocking the fibers 207 from flowing through the pores 212. In one regard, the diameters or widths of the pores 212 may be sized based on sizes of the fibers 207 in the slurry 204, e.g., the diameters of the pores 212 may be smaller than the sizes of the fibers 207. By way of particular non-limiting example, the pores 212 may have diameters of around 0.6 mm and the holes 210 may have diameters of around 2 mm. However, in some instances, the pores 212 and/or the holes 210 may have irregular shapes as may occur during 3D fabrication processes and/or other shapes, such as hexagons, pentagons, triangles, etc.

According to examples, the liquid 205 may be water or another type of suitable liquid in which fibers 207 may be mixed into the slurry 204. The fibers 207, which may also be construed as a pulp material, may be fibers of paper, wood, fibrous crops, bamboo, and/or the like. As shown, to form the wet part 202 on the forming screen 208, the forming screen 208 and the forming mold 206 may be immersed or otherwise inserted into a volume of the slurry 204. In some examples, the forming mold 206 may be mounted onto a supporting structure (not shown), in which the supporting structure may be movable with respect to the slurry 204. The supporting structure may move the forming tool 200 into the slurry 204, for instance, as shown in FIG. 2A

The forming tool 200 may be in communication with a plenum 209 to which a force application source 211 may be connected. The force application source 211 may be a vacuum device that may apply a vacuum pressure through the holes 210 in the forming mold 206 and the pores 212 in the forming screen 208. When the vacuum pressure is applied through the holes 210 and the pores 212, some of the liquid 205 in the slurry 204 may be suctioned through the holes 210 and the pores 212 and may flow into the plenum 209 as denoted by the arrows 214. As the liquid 205 flows through the holes 210 and the pores 212, the forming screen 208 may prevent the fibers 207 in the slurry 204 from flowing through the pores 212. As discussed herein, the force application source 211 may also be a blowing force device that may cause a blowing force to be applied through the holes 210 and the pores 212. In some examples, the airflow output by the force application source 211 may be reversible to cause the airflow to apply a vacuum force or a blowing force.

Over a period of time, which may be a relatively short period of time, e.g., about a few seconds, less than about a minute, less than about five minutes, or the like, the fibers 207 may build up on the forming screen 208. Particularly, the fibers 207 in the slurry 204 may be accumulated and compressed onto the forming screen 208 into the wet part 202 as shown in FIG. 2A. As the fibers 207 are accumulated, the wet part 202 may take the shape of the forming screen 208 and may have a relatively smooth first surface 203. The thickness and density of the wet part 202 may be affected by the types and/or sizes of the fibers 207 in the slurry 204, the length of time that the vacuum pressure is applied while the forming mold 206 and the forming screen 208 are placed within the volume of the slurry 204, etc. That is, for instance, the wet part 202 may be formed to have a greater thickness the longer that the vacuum pressure is applied while the forming mold 206 and the forming screen 208 are at least partially immersed in the slurry 204.

After the period of time, e.g., after the wet part 202 having desired properties, e.g., thickness, density, porosity of the fibers 207, concentration of the fibers 207, and/or the like, has been formed on the forming screen 208, the forming mold 206 and the forming screen 208 may be removed from the volume of slurry 204. For instance, a supporting structure onto which the forming tool 200 may be mounted may move the forming tool 200 away from the volume of slurry 204. In some examples, the supporting structure may rotate with respect to the volume of slurry 204 such that rotation of the movable mechanism may cause the forming mold 206 and the forming screen 208 to be removed from the volume of slurry 204. In other examples, the supporting structure may be moved laterally with respect to the volume of slurry 204. As the forming mold 206 and the forming screen 208 are removed from the volume, some of the excess slurry 204 may come off of the wet part 202. However, the wet part 202 may have a relatively high concentration of liquid 205.

Following the formation of the wet part 202 on the forming screen 208 and movement of the forming screen 208 and the wet part 202 out of the volume of slurry 204, a transfer screen 224 of a transfer tool 220 may be positioned near a second surface 213 of the wet part 202, for instance, as shown in FIG. 2B. Although not shown, the transfer mold 222 may be supported on a movable supporting structure that may move the transfer tool 220 with respect to the forming tool 200.

As shown in FIG. 2B, and according to examples, the transfer screen 224 may be moved to a position that is a predefined distance away from the forming screen 208, e.g., such that a gap 221 may exist between a bottom surface of the transfer screen 224 and the second surface 213. The predefined distance may correspond to an intended amount of decrease in the density at which the fibers 207 are to be arranged in the wet part 202. Equivalently, the predefined distance may correspond to a distance that the second surface 213 is to traverse in order for an article formed from the wet part 202 to have an intended porosity level to function as a filter that may filter out an intended percentage of airborne particulates. The predefined distance may be determined through testing, modeling, simulations, and/or the like.

As shown in FIG. 2B, the transfer tool 220 may also include a transfer mold 222, which may have a relatively larger thickness than the transfer screen 224. The larger thickness of the transfer mold 222 may cause the transfer mold 222 to be substantially more rigid than the transfer screen 224. The transfer mold 222 may provide structural support for the transfer screen 224. By way of particular non-limiting example, the transfer screen 224 may have a thickness in the range of about 1 mm and 2 mm and the transfer mold 222 may have a thickness in the range of about 5-8 mm. The thicknesses of the transfer screen 224 and/or the transfer mold 222 may be based on, for instance, characteristics of the molded fiber part processes that the transfer tool 220 is to undergo and may be similar to those listed above with respect to the forming mold 206 and the forming screen 208.

As also shown in FIG. 2B, the transfer mold 222 may include holes 226 and the transfer screen 224 may include pores 228, in which the holes 226 may have diameters that are larger than the diameters of the pores 228. For instance, the diameters of the holes 226 may be larger than the sizes of the fibers 207 whereas the diameters of the pores 228 may be smaller than the sizes of the fibers 207. That is, the pores 228 may have sufficiently small dimensions, e.g., diameters or widths, that may enable the liquid 205 to flow through the pores 228 while blocking the fibers 207 from flowing through the pores 228. In one regard, the diameters or widths of the pores 228 may be sized to be smaller than the sizes of the fibers 207 in the slurry 204. By way of particular non-limiting example, the pores 228 may have diameters of around 0.6 mm and the holes 226 may have diameters of around 2 mm. In some instances, the pores 228 and/or the holes 226 may have irregular shapes as may occur during 3D fabrication processes and/or other shapes, such as hexagons, pentagons, triangles, etc.

According to examples, a three-dimensional (3D) fabrication system may fabricate the forming screen 208 and/or the transfer screen 224. The 3D fabrication system (not shown) may be any suitable type of additive manufacturing system. Examples of suitable additive manufacturing systems may include systems that may employ curable binder jetting onto build materials (e.g., thermally or UV curable binders), print agent jetting onto build materials (e.g., fusing agent and/or detailing agent), selective laser sintering, stereolithography, fused deposition modeling, etc. In a particular example, the 3D fabrication system may form the forming screen 208 and/or the transfer screen 224 by binding and/or fusing build material particles together. In any of these examples, the build material particles may be any suitable type of material that may be employed in 3D fabrication processes, such as, a metal, a plastic (such as, a nylon), a ceramic, an alloy, and/or the like. Generally speaking, higher functionality/performance forming and transfer screens 208, 224 may be those with the smallest pore size to block fibers 207 of smaller sizes, and hence some 3D fabrication system technologies may be more suited for generating the forming and transfer screens 208, 224 than others.

With reference to FIGS. 1 and 2B, at block 104, the second surface 213 of the wet part 202 may be pulled away from the first surface 203 of the wet part 202 while a suction force is applied onto the first surface 203 through the pores 212 in the forming screen 208 to cause a density at which the fibers are arranged in the wet part 202 to be decreased. As shown in FIG. 2B, the transfer tool 220 may be in communication with a plenum 223 to which the force application source 211 may be connected such that the force application source 211 may apply a vacuum pressure through the holes 226 in the transfer mold 222 and the pores 228 in the transfer screen 224. Although a common force application source 211 is depicted in FIG. 2C as applying vacuum force to both of the plenums 209, 223, it should be understood that force may be applied to the plenum 223 by a separate force application source.

As shown in FIG. 2C, the force application source 211 may apply vacuum force, or equivalently, a suction force, to both of the plenums 209, 223 such that the vacuum force may be applied to both of the first and second surfaces 203, 213 of the wet part 202. That is, the first surface 203 may be pulled to remain in contact with the forming screen 208 and the second surface 213 may be pulled to be in contact with the transfer screen 224. In this regard, the second surface 213, as well as some of the fibers 207 in the wet part 202 may be pulled toward the transfer screen 224 to cause the gap 221 to be filled by the wet part 202. The expansion of the wet part 202 may result in the density at which the fibers 207 are arranged in the wet part 202 to be decreased. In other words, the expansion of the wet part 202 may result in the fibers 207 in the wet part 202 to be more spaced apart from each other as compared with the arrangement of the fibers 207 prior to the vacuum force being applied on the second surface 213 of the wet part 202.

In other examples, following formation of the wet part 202 on the forming screen 208, the transfer screen 224 may be brought into contact with the second surface 213 of the wet part 202. In these examples, the transfer screen 224 may be moved the predefined distance that corresponds to the intended amount of decrease in the density at which the fibers 207 are arranged in the wet part 202 while the vacuum pressure is applied onto the second surface 213 of the wet part 202 to pull the second surface 213 and while the vacuum pressure is applied onto the first surface 203 of the wet part 202.

Application of the vacuum pressure on the second surface 213 of the wet part 202 may also result in some of the liquid 205 in the wet part 202 being removed from the wet part 202 through the second surface 213 as denoted by the arrows 225. Likewise, application of the vacuum pressure on the first surface 203 of the wet part 202 may result in some of the liquid 205 in the wet part 202 being removed from the wet part 202 through the first surface 203 as denoted by the arrow 214. As a result, the application of the vacuum pressures on the first and second surfaces 203, 213 may result in the wet part 202 being partially de-watered. The partial de-watering of the wet part 202 may cause the fibers 207 to remain, or equivalently, to be set, in their reduced density arrangements. In addition, by partially de-watering the wet part 202, the amount of energy used to fully dry the wet part 202 following removal of the wet part 202 from the transfer screen 224, such as in an oven, may significantly be reduced as discussed herein.

Application of the vacuum pressure on the second surface 213 of the wet part 202 through the transfer screen 224 may further result in the second surface 213 having a contour that matches the contour of the transfer screen 224. In addition, the second surface 213 may be caused to have a relatively smooth surface. In some examples, the second surface 213 may have a smoothness that is equivalent to the smoothness of the first surface 203. In other words, the second surface 213 may have a smoothness that is similar, e.g., within a certain level of difference, to the smoothness of the first surface 203.

At block 106, following a predefined length of time after initiation of the pulling of the second surface 213 away from the first surface 203, the wet part 202 may be removed from the forming screen 224, as shown in FIG. 2D. The predefined length of time may correspond to a length of time during which the vacuum force may be applied onto both the first and second surfaces 203, 213 of the wet part 202 to cause the fibers 207 in the wet part 202 to remain at an expanded state following removal of the vacuum forces. In other words, the predefined length of time may correspond to a length of time that may cause the wet part 202 to be partially dewatered and the fibers 207 in the wet part 202 to partially be set in place. The predefined length of time may depend upon any of a number of factors, such as the concentration of the liquid 205 in the wet part 202, the density at which the fibers 207 are arranged in the wet part 202, the amount of vacuum force applied, and/or the like. In addition, the predefined length of time may be determined through testing, modeling, simulations, and/or the like.

To remove the wet part 202 from the forming screen 208, the force application source 211 may continue to apply the vacuum force onto the wet part 202 through the transfer tool 220 while the transfer tool 220 is moved in a direction away from the forming tool 200. In addition, the force application source 211 may cease application of the vacuum force through the forming tool 200 while the transfer tool 220 is moved away from the forming tool 200. In other examples, and as shown in FIG. 2D, the force application source 211 may cause a blowing force to be applied through the pores 212 of the forming screen 208 to push the wet part 202 off of the forming screen 208 toward the transfer screen 224.

The force application source 211 may continue to cause the vacuum force to be applied onto the wet part 202 while the transfer tool 220 is continued to be moved away from the forming tool 200. When the transfer tool 220 reaches a certain destination, such as a location corresponding to a next phase in a process of forming an article from the wet part 202, the transfer tool 220 may release the wet part 202 from the transfer screen 224. For instance, the transfer tool 220 may transfer the wet part 202 from the forming tool 200 to an oven (not shown) or a conveyor that may carry the wet part 202 to an oven. To release the wet part 202 from the transfer screen 224, the force application source 211 may cease application of the vacuum force onto the wet part 202. In some examples, the force application source 211 may cause a blowing force to be applied through the transfer tool 220 to push the wet part 202 off of the transfer screen 224.

According to examples, a pressing operation onto the wet part 202 may not be performed during or following transfer of the wet part 202 from the forming tool 200. For instance, an operation to squeeze additional liquid 205 from the wet part 202 may not be performed as such an operation may compress the fibers 207 in the wet part 202 and cause the fibers 207 in the wet part 202 to be more densely packed with respect to each other.

According to examples, an article may be formed from the wet part 202 following drying of the wet part 202 in an oven or other drying device. In other examples, the wet part 202 may be dried naturally, e.g., by being placed in a dry environment for a period of time. The article may function as a filter for filtering out airborne particulates. For instance, the fibers 207 in the wet part 202 may be set with respect to each other with a sufficient strength to maintain an intended shape and a sufficient porosity to filter out an intended percentage of airborne particulates when the wet part 202 is dried. In the present disclosure, the percentage of airborne particulates may correspond to a percentage of airborne particulates of a certain size or larger.

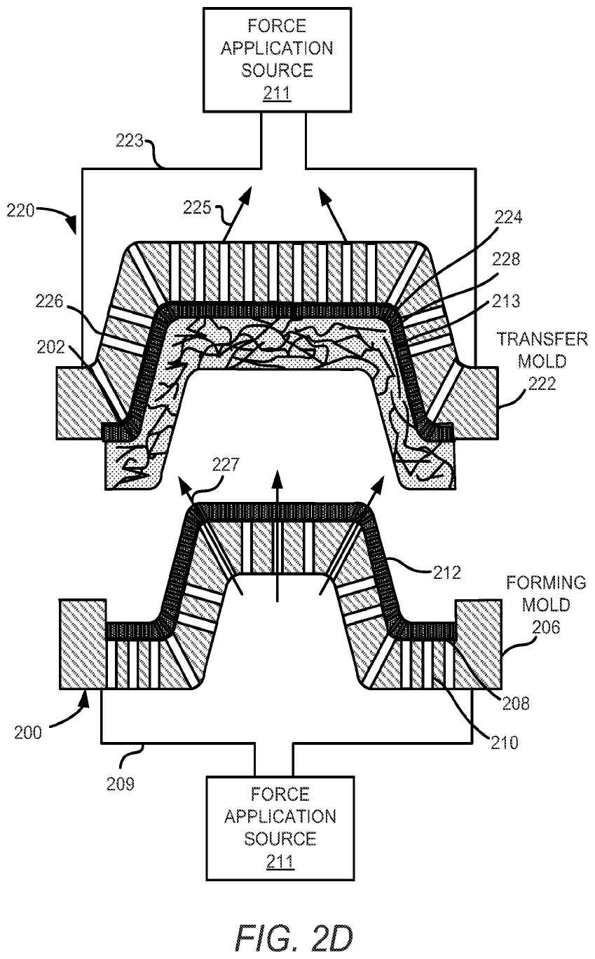

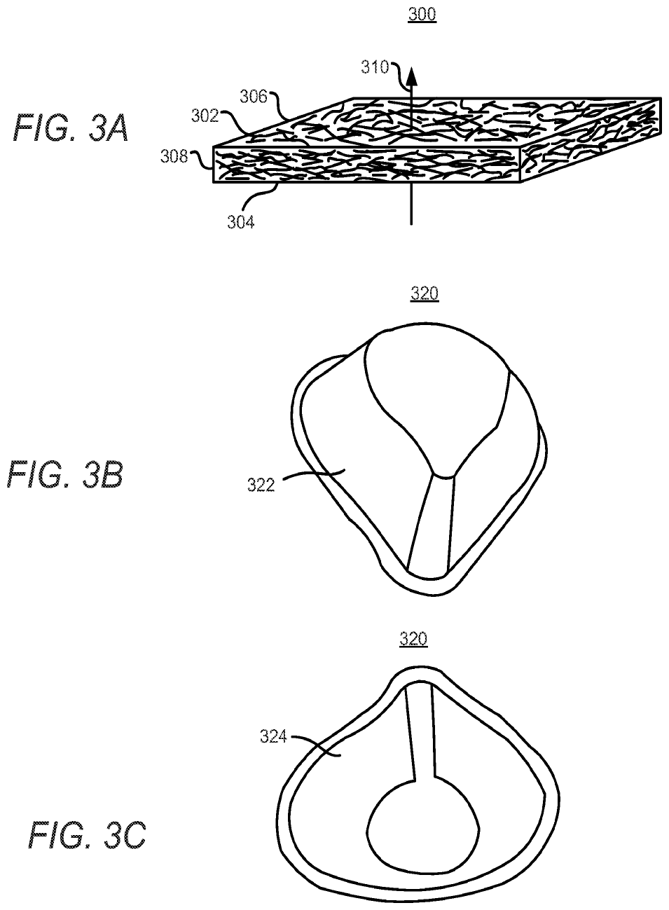

Example articles 300, 320 that may be formed from a wet part 202 as described herein are depicted in FIGS. 3A-3C. Particularly, FIG. 3A depicts an isometric diagram of an example article 300 formed of molded fibers 302, in which the article 300 may be porous and may allow a predefined level of fluid to flow through the article 300. FIG. 3B depicts a perspective top view of an example article 320 and FIG. 3C depicts a perspective bottom view of the example article 320, in which the example article 320 may be a face mask. It should be understood that the example articles 300, 320 depicted in FIGS. 3A-3C may include additional attributes and that some of the attributes described herein may be removed and/or modified without departing from the scopes of the example articles 300, 320 depicted in FIGS. 3A-3C.

As shown in FIG. 3A, the article 300 may include a first surface 304 and a second surface 306 formed of molded fibers 302 from a slurry 204 of the fibers 302. The article 300 may also include an interior section 308 formed between the first surface 304 and the second surface 306, in which the interior section 308 may also be formed of the molded fibers 302. In some examples, the molded fibers 302 in the first surface 304, the second surface 306, and the interior section 308 may be arranged at a density level with respect to each other to be porous and to allow a predefined level of fluid to flow through the article 300. The fluid flow through the article 300 is represented by the arrow 310.

The article 300 may function as a filter that may filter out particulates in the fluid that flows through the article 300, such as a gas filter, a liquid filter, and/or the like. The article 300 may be implemented in any suitable type of environment and/or application. In a particular example, and as shown in FIGS. 3B and 3C, the article 300 may be a face mask 320, e.g., a filtering face mask, that is molded to fit over a nose and a mouth of a wearer of the face mask. The face mask 320 may include a first surface 322, which may also be termed an outer surface of the article face mask 320 and a second surface 324, which may also be termed an inner surface of the face mask 320. The face mask 320 may be equivalent to the article 300 and thus, the first surface 322 may be equivalent to the first surface 304 in the article 300 and the second surface 324 may be equivalent to the second surface 306 in the article 300. The interior of the article 320 may also be equivalent to the interior section 308 of the article 300.

As discussed herein, the article 300, e.g., face mask 320, may be formed of fibers 207 that may have been molded to have the shapes shown in FIGS. 3A-3C. In some examples, the fibers 207 may be arranged in the article 300, 320 with a porosity that may enable the article 300, 320 to filter out a minimum of about 90 percent of airborne particles or particulates while enabling air to flow through the article 300, 320. In other examples, the fibers 207 may be arranged in the article 300, 320 to filter out a minimum of about 95 percent of airborne particles or particulates while enabling air to flow through the article 300, 320. The fibers 207 may be arranged in the article 300, 320 to filter out the airborne particulates while enabling a wearer of the article 300, 320 to breathe through the article 300, 320.

According to examples, the article 300, 320 may be fabricated through implementation of a molded fiber part fabrication operation as discussed herein, in which pressure may be applied to both a first surface and a second surface of a wet part 202 from which the article 300, 320 may be formed. In some examples, the application of the pressure on both the first and second surfaces of the wet part 202 may result in the smoothness of the first surface 304, 322 being equivalent to the smoothness of the second surface 306, 324.

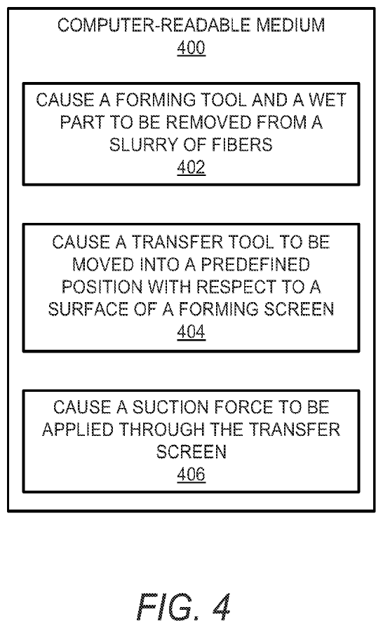

Turning now to FIG. 4, there is shown a block diagram of an example computer-readable medium 400 that may have stored thereon computer-readable instructions for causing a second surface 213 of a wet part 202 formed on a forming screen 208 to be pulled away from a first surface 203 of the wet part 202 to decrease a density at which fibers 207 in the wet part 202 are arranged. It should be understood that the example computer-readable medium 400 depicted in FIG. 4 may include additional attributes and that some of the attributes described herein may be removed and/or modified without departing from the scope of FIG. 4.

The computer-readable medium 400 may have stored thereon computer-readable instructions 402-406 that a processor may execute. The processor may be a semiconductor-based microprocessor, a central processing unit (CPU), an application specific integrated circuit (ASIC), a field-programmable gate array (FPGA), and/or other suitable hardware device. The processor may be part of a computing device that may control a pulp molded fiber fabrication machinery. In other examples, the processor may be part of the pulp molded fiber fabrication machinery.

The computer-readable medium 400 may be an electronic, magnetic, optical, or other physical storage device that contains or stores executable instructions. The computer-readable medium 400 may be, for example, Random Access memory (RAM), an Electrically Erasable Programmable Read-Only Memory (EEPROM), a storage device, an optical disc, and the like. Generally speaking, the computer-readable medium 400 may be a non-transitory computer-readable medium, in which the term “non-transitory” does not encompass transitory propagating signals.

The processor may fetch, decode, and execute the instructions 402 to cause a forming tool 200 and a wet part 202 formed of fibers 207 to be removed from a slurry 204 of fibers 207. A first surface 203 of the wet part 202 may be in contact with a forming screen 208 of the forming tool 200. For instance, the processor may control a motor of a supporting structure that may support the forming tool 200 to remove the forming tool 200 from the slurry 204 at some set time after the forming tool 200 was immersed into the slurry 204.

The processor may fetch, decode, and execute the instructions 404 to cause a transfer screen 224 of a transfer tool 220 to be moved into a predefined position with respect to a surface of the forming screen 208. The processor may control a motor of a supporting structure that may support the transfer tool 220 to move the transfer tool 220 and the transfer screen 224 to the predefined position with respect to the forming screen 208. An example of this arrangement is depicted in FIG. 2B. As discussed herein, the predefined position may correspond to a predefined distance between the transfer screen 224 and a second surface 213 of the wet part 202. The predefined distance may correspond to an intended amount of decrease in the density at which the fibers 207 are arranged in the wet part 202. Similarly, the predefined distance may correspond to an intended increase in a porosity of the fibers 207 in the wet part 202.

The processor may fetch, decode, and execute the instructions 406 to cause a suction force to be applied through the transfer screen 224 and onto the second surface 213 of the wet part 202 while a suction force is applied through the forming screen 208. As discussed herein, the suction force applied through the transfer screen 224 is to pull the second surface 216 of the wet part 202 toward the transfer screen 224 while the suction force applied through the forming screen 208 is to pull the first surface 203 toward the forming screen 208 to decrease a density at which the fibers 207 in the wet part 202 are arranged. The processor may cause the suction force to be applied through the transfer screen 224 and onto the second surface 213 of the wet part 202 while the suction force is applied through the forming screen 208 for a predetermined length of time. The predetermined length of time may cause sufficient force to be applied to the wet part 202 and for a sufficient length of time to cause an article 300, 320 formed from the wet part 202 after the wet part 202 is dried to have a predefined fluid flow resistance level. The predetermined length of time may be based on any number of factors and may be determined through testing, modeling, simulation, and/or the like.

The processor may cause the suction force to be applied through the forming screen 208 while the forming screen 208 is immersed in the slurry 204 of fibers 207 to cause some of the fibers 207 in the slurry 204 to be suctioned onto the forming screen 208. The processor may control a force application source 211 to cause the suction force to be applied through the forming screen 208. In addition, the processor may cause the suction force to be maintained through the forming screen 208 for a predefined length of time, in which the predefined length of time may cause the wet part 202 to be formed on the forming screen 208 to have a predefined thickness. The predefined thickness may correspond to a thickness that the wet part 202 may have prior to being expanded to have the decreased density.

The processor may, after a predefined length of time, cause the suction force applied through the forming screen 208 to be ceased and may cause a blowing force to be applied through the forming screen 208. The processor may control the force application source 211 to create the blowing force to be applied through the forming screen 208. The processor may also cause the transfer tool 220 to be moved away from the forming tool 200 while the suction force applied through the transfer screen 224 is maintained and the blowing force is applied through the forming screen 208 to cause the wet part 202 to be transferred from the forming tool 200 to the transfer tool 220. In some examples, however, the wet part 202 may be transferred from the forming screen 208 to the transfer screen 224 without the blowing force being applied through the forming screen 208.

As discussed herein, an article 300, 320 that may function as a filter may be formed from the wet part 202 following drying of the wet part 202. That is, following removal of all or most of the liquid 205 from the wet part 202, for instance, by drying the wet part 202, the wet part 202 may form into an article 300, 320. The processor may cause the suction force to be applied through the transfer screen 224 and onto the second surface 213 of the wet part 202 while the suction force is applied through the forming screen 224 for a predetermined length of time, in which the predetermined length of time is to cause the article 300, 320 to have a predefined fluid flow resistance level. The predetermined length of time may be determined through testing, modeling, simulation, and/or the like.

In a particular example, the article 300, 320 may function as a filter for a face mask, or equivalently, a filtering face mask, that may filter out a minimum of 95 percent of airborne particulates having a certain size or larger. In this example, the processor may cause the suction force to be applied through the transfer screen 224 and onto the second surface 213 of the wet part 202 while the suction force is applied through the forming screen 208 for a predetermined length of time. The predetermined length of time may cause the article 300, 320 to have an ability to filter out a minimum of 95 percent of airborne particles when in use, for instance, as a face mask by a wearer of the article.

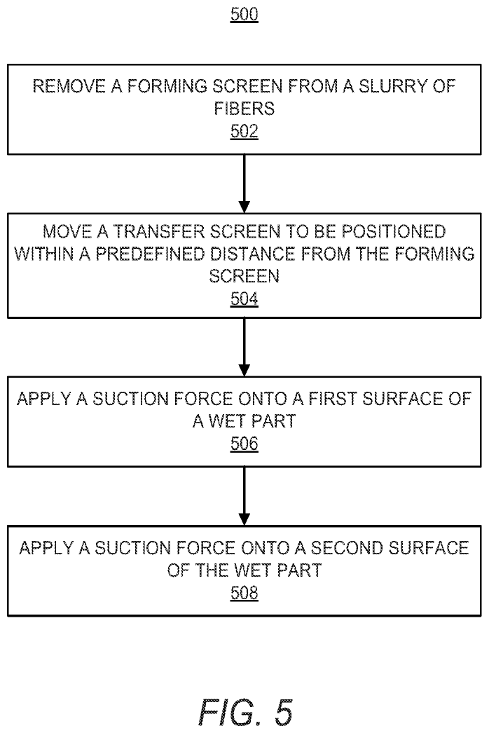

Reference is now made to FIG. 5, which shows a flow diagram of an example method 500 for de-densifying a wet part 202 formed of fibers 207. It should be understood that the example method 500 may include additional attributes and that some of the attributes described herein may be removed and/or modified without departing from the scopes of the method 500. The description of the method 500 is made with reference to the features shown in FIGS. 1-3 for purposes of illustration.

At block 502, a forming screen 208 may be removed from a slurry 204 of fibers 207 following formation of a wet part 202 composed of some of the fibers 207 on the forming screen 208. A first surface 203 of the wet part 202 may be in contact with the forming screen 208.

At block 504, a transfer screen 224 may be positioned within a predefined distance from the forming screen 208. In addition, at block 506, a first suction force may be applied through the forming screen 208 onto the first surface 203 of the wet part 202. Moreover, at block 508, a second suction force may be applied through the transfer screen 224 and onto a second surface 213 of the wet part 202. Application of the first suction force and the second suction force may cause the wet part 202 to be de-densified.

As discussed herein, following a predetermined length of time after the suction force is applied through the transfer screen 224, application of the first suction force through the forming screen 208 may be ceased. In addition, a blowing force may be applied through the forming screen 208 onto the first surface 203 of the wet part 202 to remove the wet part 202 from the forming screen 224. The transfer tool 220 may also be moved away from the forming tool 220 while the second suction force is applied through the transfer screen 224 and the blowing force may be applied through the forming screen 208 to cause the wet part 202 to be transferred from contact with the forming screen 208 to contact only with the transfer screen 224.

As also discussed herein, both the first suction force and the second suction force may be applied for a predetermined length of time prior to ceasing application of the first suction force. The predetermined length of time may cause the wet part 202 to function as a face mask filter when the wet part 202 is dried. In addition, the face mask filter is to filter out a minimum of a predefined percentage of airborne particles when in use.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method comprising:
forming a wet part composed of fibers from a slurry of the fibers on a forming screen having pores, the wet part having a first surface in contact with the forming screen;
pulling a second surface of the wet part away from the first surface of the wet part while a suction force is applied onto the first surface through the pores in the forming screen to cause a density at which the fibers are arranged in the wet part to be decreased; and
following a predefined length of time after initiation of the pulling of the second surface away from the first surface, removing the wet part from the forming screen, wherein an article formed from the wet part is to function as a filter following the wet part being dried.

2. The method of claim 1, wherein pulling the second surface away from the first surface further comprises:
positioning a transfer screen near the second surface of the wet part; and
causing a suction force to be applied onto the second surface of the wet part through pores in the transfer screen, wherein the suction force applied through the pores in the transfer screen is to pull the second surface away from the first surface and toward the transfer screen.

3. The method of claim 2, further comprising:
following expiration of the predefined length of time, causing a blowing force to be applied through the pores of the forming mold to push the wet part toward the transfer screen, wherein the transfer screen is to pull the wet part away from the forming screen.

4. The method of claim 2, wherein positioning the transfer screen further comprises positioning the transfer screen to be moved to a position that is a predefined distance away from the forming screen, wherein the predefined distance corresponds to an intended amount of decrease in the density at which the fibers are arranged in the wet part.

5. The method of claim 1, further comprising:
causing a suction force to be applied onto the second surface of the wet part and the suction force to be applied onto the first surface of the wet part for the predefined length of time, wherein the predefined length of time is to cause the wet part to be partially dewatered and the fibers in the wet part to partially be set in place.

6. The method of claim 1, further comprising:
causing a suction force to be applied onto the second surface of the wet part and the suction force to be applied onto the first surface of the wet part for the predefined length of time, wherein the predefined length of time is to cause the wet part to be partially dewatered and the fibers in the wet part to partially be set, and wherein the fibers are to function as an airborne particulate filter that is to filter a minimum of a predefined percentage of airborne particulates when the wet part is dried.

7. A non-transitory computer-readable medium on which is stored machine-readable instructions that when executed by a processor, cause the processor to:
cause a forming tool and a wet part formed of fibers to be removed from a slurry of fibers, wherein a first surface of the wet part is in contact with a forming screen of the forming tool;
cause a transfer screen of a transfer tool to be moved into a predefined position with respect to a surface of the forming screen; and
cause a suction force to be applied through the transfer screen and onto a second surface of the wet part while a suction force is applied through the forming screen, wherein the suction force applied through the transfer screen is to pull the second surface of the wet part toward the transfer screen while the suction force applied through the forming screen is to pull the first surface toward the forming screen to decrease a density at which the fibers in the wet part are arranged.

8. The non-transitory computer-readable medium of claim 7, wherein the instructions cause the processor to:
cause the suction force to be applied through the forming screen while the forming screen is immersed in the slurry of fibers to cause some of the fibers to be suctioned onto the forming screen; and
cause the suction force to be maintained through the forming screen for a predefined length of time, wherein the predefined length of time is to cause the wet part to be formed on the forming screen to have a predefined thickness.

9. The non-transitory computer-readable medium of claim 7, wherein the instructions cause the processor to:
after a predefined length of time,
cause the suction force applied through the forming screen to be ceased;
cause a blowing force to be applied through the forming screen; and
cause the transfer tool to be moved away from the forming tool while the suction force applied through the transfer screen is maintained and the blowing force is applied through the forming screen to cause the wet part to be transferred from the forming tool to the transfer tool.

10. The non-transitory computer-readable medium of claim 7, wherein the instructions cause the processor to:
cause the suction force to be applied through the transfer screen and onto the second surface of the wet part while the suction force is applied through the forming screen for a predetermined length of time, wherein the predetermined length of time is to cause sufficient force to be applied to the wet part and for a sufficient length of time to cause an article formed from the wet part after the wet part being dried to have a predefined fluid flow resistance level.

11. The non-transitory computer-readable medium of claim 7, wherein an article formed from the wet part following drying of the wet part is to function as a filter, and wherein the instructions cause the processor to:
cause the suction force to be applied through the transfer screen and onto the second surface of the wet part while the suction force is applied through the forming screen for a predetermined length of time, wherein the predetermined length of time is to cause the article to have a predefined fluid flow resistance level.

12. The non-transitory computer-readable medium of claim 7, wherein an article formed from the wet part following drying of the wet part is to function as a filter for a face mask that is to filter out a minimum of 95 percent of airborne particulates of a certain size or larger following drying of the wet part, and wherein the instructions cause the processor to:
cause the suction force to be applied through the transfer screen and onto the second surface of the wet part while the suction force is applied through the forming screen for a predetermined length of time, wherein the predetermined length of time is to cause the article to have an ability to filter out a minimum of 95 percent of airborne particles of a certain size or larger when in use.

13. A filter comprising:
a first surface formed of molded fibers;
a second surface formed of molded fibers; and
an interior section between the first surface and the second surface, the interior surface being formed of molded fibers, wherein:
the molded fibers in the first surface, the second surface, and the interior section are arranged at a density level that enables at least a predefined percentage of particles in a fluid to be filtered when the filter is in use; and
the first surface, the second surface, and the interior section are formed from a wet part composed of fibers from a slurry of the fibers on a forming screen having pores, the wet part having a first section in contact with the forming screen, wherein a second section is pulled away from the first surface to cause a density at which the fibers are arranged in the wet part to be decreased.

14. The filter of claim 13, wherein the filter comprises a filtering face mask.

15. The filter of claim 13, wherein the first surface, the second surface, and the interior section are formed through application of both a first suction force through the forming screen on the first section and a second suction force through a transfer screen on the second section for a predetermined length of time prior to ceasing application of the first suction force, wherein the predetermined length of time is to cause the wet part to function as the filter when the wet part is dried, wherein the filter is to filter out a minimum of a predefined percentage of particles when in use.
